(19) United States
(12) Patent Application Publication
(10) Pub. No.: US 2006/0014009 A1
(43) Pub. Date: Jan. 19, 2006

(54) Safe T flooring

(76) Inventor: Kirt Weidner, Birdsboro, PA (US)

Correspondence Address: Eugene E. Renz, Jr., P.C., 205 North Monroe Street, Post Office Box 2056, Media, PA, 19063-9056, US

(21) Appl. No.: 11/182,196

(22) Filed: Jul. 14, 2005

Related U.S. Application Data
(60) Provisional application No. 60/589,057, filed on Jul. 19, 2004.

(51) Int. Cl. B32B 3/26; B32B 5/20

(52) U.S. Cl. 428/304.4; 428/318.8

(57) ABSTRACT

A cushioned flooring system that utilizes a flexible membrane over closed cell foam. The flexible membrane may be vinyl or linoleum, over a closed cell foam substrate to provide cushioning and shock absorption. This system would be utilized in kitchens, bathrooms and any other areas where vinyl or linoleum are typically used. The closed cell foam can range in thickness from 3/8″ to 1½″ and will be permanently bonded to the flexible membrane. Dependent on the foam thickness, this system will provide cushioning if a slip and fall occurs and will relieve the fatigue associated with working and standing extensively on a hard flooring surface. The installed system can form a wall to wall covering, or it can be used as a mat to localize the area of protection and/or comfort. The bottom side of the closed cell foam is adapted to be bonded to the floor and/or wall in the wall to wall configuration and left bare when used as a mat. The mats are designed in several configurations. These configurations range from rectangular mats to mats of any custom design. These mats may wrap around the toilet and/or set in front of the tub, with a long rectangular section leading to such areas. These mats will have formed edges, providing an angled approach, thereby easing the egress into the mat surface.

This Regular Patent Application claims the benefit of Provisional Patent Application No. 60/589,057, filed Jul. 19, 2004, entitled SAFE T FLOORING.

### FIELD OF THE INVENTION

The present invention relates to a cushioned flooring system comprising a flexible membrane adhered to a core made of a closed cell foam. More specifically, the present invention relates to a flooring system characterized by novel features of construction and arrangement combining an anti-slip surface and a cushioned core providing slip and fall protection. The system is particularly useful in elder care facilities such as nursing homes and assisted living places.

### BACKGROUND OF THE INVENTION

In the residential and commercial flooring industry, it is common place to use a multitude of hard surface floorings. Focusing on the commercial industry, there is an arena of applications and sectors for the hard surface floorings. The following lists the various industries typically using hard surface floorings-medical (i.e. hospitals, laboratories, doctor's offices, health care (i.e nursing homes, assisted living homes) restaurants and catering, beauty (i.e. hair salons), and miscellaneous industries requiring associates to work for long time periods in a standing position. Regarding the residential industry, the residential home is in use of hard surface floorings, such as bathrooms, bedrooms, and kitchens.

For the industries discussed, the hard surface floors encompass tile, marble, stone, linoleum and vinyl floor coverings. In the installation of the tile, marble or stone, it is known to place the constituent on top of the backer/cement board over the wood sub-flooring and an adhesive layer to bond the materials to the backer board. Grout is applied to fill the areas between the tile and provides a non-permeable surface. In the installation of linoleum and vinyl floor coverings, it is know to place and adhesive on top of either the previous linoleum or vinyl flooring, wood subflooring or concrete; thereby, the replacement linoleum or vinyl flooring adheres to the substrate and provides a smooth surface from which to travel on and a non-permeable surface.

Due to the fact that the hard surfaces are most often used in areas of high moisture, it is probable that a slip and fall will occur. In conjunction with this slip and fall potential, body fatigue, particularly to the lower back and legs, may result from these hard flooring surfaces. Although these conventional flooring systems are designed for durability and easy cleaning, they provide no protection during a slip and fall and are uncomfortable when stood on for long time periods.

It is desirable to reduce the severity of slip and fall and to provide an ergonomic flooring solution. This solution would come in the form of a wall to wall configuration, as well as, mats in an assortment of designs and thickness.

Composite floor assemblies are not new per se as shown by the prior art patents listed below:

| INVENTOR | TITLE | DATE OF PATENT | PATENT NO. |
|---|---|---|---|
| E. Brunner | Resilient Mat | Jan. 9, 1962 | 3,016,317 |
| J. Trager | De-Icing Pad | Mar. 22, 1966 | 3,242,034 |
| D.K. Slosberg | Floor Construction | Jun. 23,1970 | 3,516,894 |
| S. Wood | Playing Court Surface | Nov. 13,1973 | 3,771,787 |
| | And Method of Constructing | | |
| | Same | | |
| W. Lewicki, Jr. | Mechanically Embossed | Apr. 27, 1976 | 3,953,639 |
| | Resilient Laminar | | |
| | Floor Material | | |
| F. Klaffke, et al. | Lay-Flat Flooring | Oct. 23, 1979 | 4,172,168 |
| | Slab | | |
| J. Cunningham, et al. | Polyester/Vinyl Chloride | Jun. 17, 1980 | 4,208,468 |
| | Polymer Laminates | | |
| L. Vargo | Disposable Floor | May 4, 1982 | 4,328,275 |
| | Mat | | |
| G. Sims | Manufacture of Covered | May 24, 1983 | 4,385,090 |
| | Foam Products | | |
| J. D'Luzansky | Modular Locking | Oct. 1, 1991 | 5,052,158 |
| | Floor Covering | | |
| R. Wilson | Floor and Countertop | Aug. 22, 1995 | 5,443,885 |
| | Protector Pad | | |
| K. Shih, et al. | Stain Blocking | Apr. 6, 1999 | 5,891,294 |
| | Barrier Layer | | |
| D. Fiechtl | Floating Floor | Feb. 20, 2001 | 6,189,279 |
| | Underlay | | |
| J. Conrad, et al. | Flexible Mat for | Jun. 12, 2001 | 6,245,697 |
| | Absorbing Liquids | | |
| | Comprising Polymeric | | |
| | Foam Materials | | |
| M. Callas | Method of Making | Jul. 10, 2001 | 6,258,202 |
| | Mat | | |
| S. Daley | Customized Cushioned | Aug. 21, 2001 | 6,277,233 |
| | Floor Mat and Method | | |
| | Of Producing Same | | |
| W. Burke, et. al. | Electrostatic Dissipating | Jul. 5, 2003 | 6,591,560 |
| | Floor Article | | |
| W. Burke, et al. | Cushioned Rubber Floor | Jul. 29, 2003 | 6,599,615 |
| | Article for Use in Hair Styling | | |
| | Salons and Other Service | | |
| | Environments | | |
| G. Seal | Disposable Restroom | Oct. 3, 2002 | US 2002/0142125 |
| | Floor Mats | | |

### SUMMARY OF THE INVENTION

The invention utilizes closed cell foam core under a flexible membrane to provide cushioning and shock absorption. This flexible membrane can be made from numerous, non-porous flexible materials and shall provide a barrier between the foam and the environment. The closed cell foam can range in thickness of ⅜″ to 1½″ and in a preferred embodiment has a micro-bacterial growth inhibitor to reduce mold and mildew growth. The foam shall be permanently bonded to the flexible membrane. The system can be installed to form a wall to wall covering or it can be used as a mat to localize the area of protection and/or comfort. Mats can be made in several different configurations from a standard rectangle to a fully custom design based upon customer needs. The mats will have perimeter edges angled to ease the egress onto the mat surface. The system will provide cushioning to reduce fatigue from standing for long time periods and shock absorption if a slip and fall occurs. The protection level will be dependent upon the thickness of the closed cell foam. In one embodiment of the invention, the flexible membrane extends beyond at least one edge of the foam core to accomodate an installation as shown in FIG. 2 wherein the extended portion of the membrane can be secured to a vertical wall and simulate a baseboard or the like.

In accordance with an embodiment of the invention, the mat is a generally rectangular and has a frusto-conical section defining two slanted edges. This mat is designed to underlie beds in an elder care facility such as a nursing home wherein the beveled edges accommodate beds having different length dimensions between the front and rear wheels. By this configuration, the mat is sure to fit under beds of different sizes wherein the distance between the front and rear wheel supports may vary. In accordance with this embodiment, a flexible ramp is fitted to the mat around the periphery thereof to provide a flexible non-slip merger of the mat with the floor to protect against tripping and ensuring against injury to a patient. Further, the flexible ramp is provided with a series of ribs to prevent slippage when positioning a wheelchair on the mat for transport of a patient from the bed to another location in the facility.

### BRIEF DESCRIPTION OF THE DRAWINGS

These and other objects of the present invention and various features and details of the operation and construction thereof are hereinafter more fully set forth with reference to the accompanying drawings wherein:

FIG. 1 represents a cross-sectional view in a typical wall to wall installation of this invention. The cushioned flooring system is trimmed to fit the desired location and is permanently bonded to the original flooring or subfloor.

FIG. 2 displays a cross-sectional view of a variation of a wall to wall installation where the flexible membrane transverses the wall, using the same trimming and bonding techniques described in FIG. 1.

FIG. 3 is a partial cross-sectional view showing an angle ranging from 15°-45° for the perimeter of a mat style construction.

FIG. 4 shows a rectangular mat. The mat's length, width and thickness dimensions are variable dependant upon needs and demands. Thickness is variable between ⅜″ to 1½″. The outer perimeter will be angled in conformance to FIG. 3.

FIG. 5 displays a variation of the mat concept. This custom design surrounds the toilet area and provides cushioning outside of the tub area. Also, this design displays a runner section, leading to a larger coverage area. Thickness is variable between ⅜″ to 1½″ and is dependent of the application. The outer perimeter will be angled in conformance to FIG. 3.

FIG. 6 is a perspective view of a flexible non-skid ramp for use around the periphery of a mat of the type shown in FIGS. 8-10 inclusive;

FIG. 7 is an enlarged transverse sectional view showing the configuration and details of the ramp;

FIG. 8 is a plan view of a mat and ramp assembly in accordance with the present invention;

FIGS. 9 and 10 are plan views showing the mat positioned under along one side of a patient's bed.

### BRIEF DESCRIPTION OF PREFERRED EMBODIMENTS

Referring now to the drawings and particularly to FIGS. 1-5 thereof, there is shown a cushioned flooring system in accordance with the present invention. FIG. 1 is a cross-sectional view of a typical wall to wall installation; wherein the closed cell foam (1) and the flexible membrane (2) are trimmed to fit into the desired area. The closed cell foam (1) and the flexible membrane (2) may be permanently pre-bonded together, which does not use an adhesive (3) prior to being trimmed. Alternatively, the closed cell foam (1) and the membrane (2) may be trimmed individually and then permanently bonded together using adhesive (3). Adhesive (3) is applied to the sub-floor or pre-existing flooring (5) to permanently bond the closed cell foam (1) and thus the flexible membrane (2). Next, colored caulk or adhesive (4) is applied to fill the gaps around the flooring edges thereby sealing and bonding the flooring edges to the wall (6).

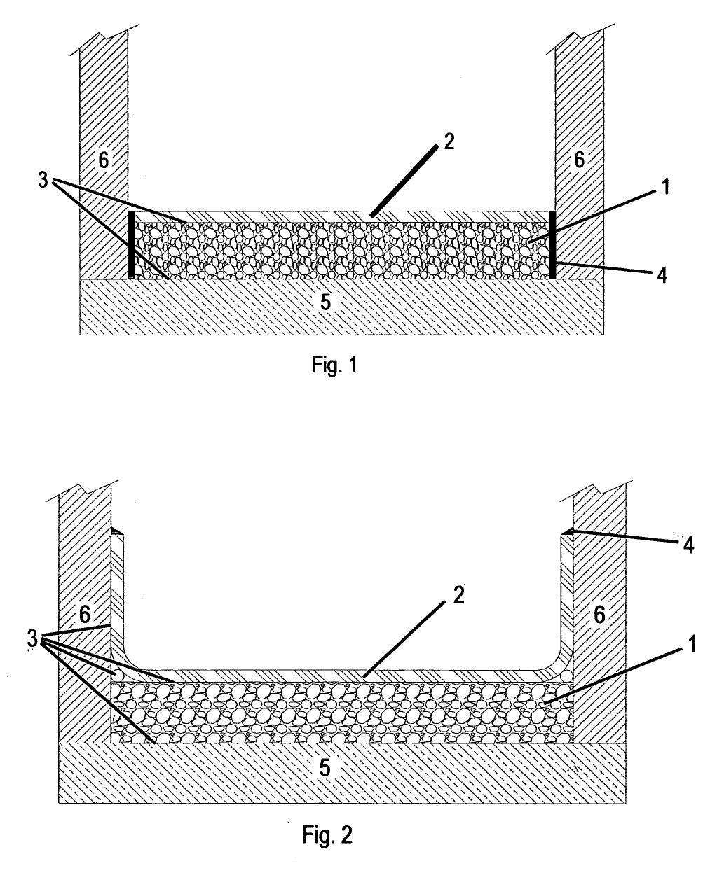

FIG. 2 is a variation of a wall to wall installation. This drawing shows the flexible membrane (2) transversing the wall (6) to provide additional protection to the wall. The closed cell foam (1) is trimmed to fit the desired area. Next, the closed cell foam (1) is bonded to the sub-floor or pre-existing flooring (5) using adhesive (3). The flexible membrane (2) is trimmed to a predetermined additional length to account for the desired amount of wall (6) protection. The flexible membrane (2) is then permanently bonded to the closed cell foam (1) using adhesive (3). Also, in this embodiment of flooring the flexible membrane (2) has an extension (2a) along at least one edge of the foam core (1) so that in installation as shown in FIG. 2, the extended portion can be secured to a wall vertifical to the floor to simulate a baseboard or the like. The flexible membrane (2) is bonded to the wall (6) and a color caulk or adhesive (4) is applied to the top edge of the flexible membrane (2). This seals and bonds the edge of the flexible membrane (2).

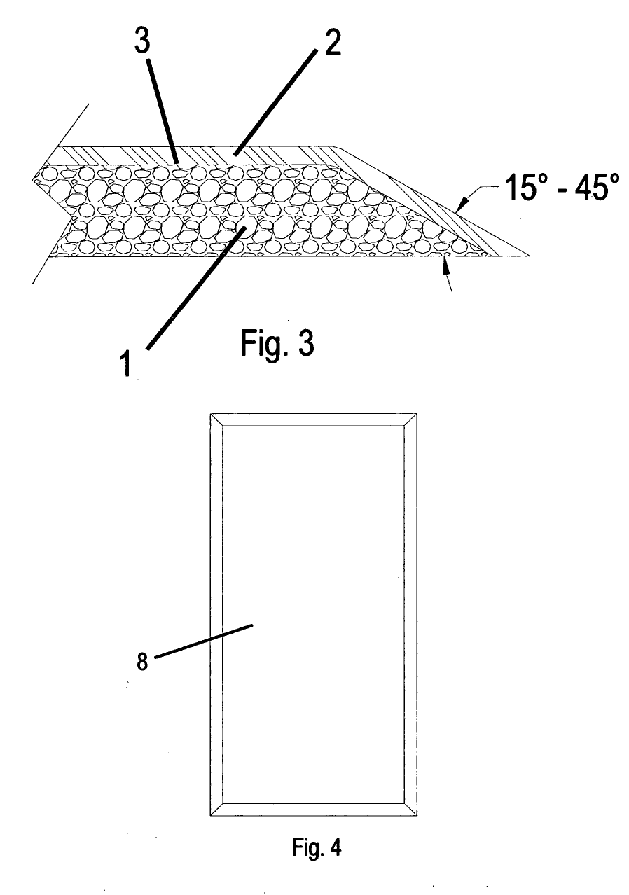

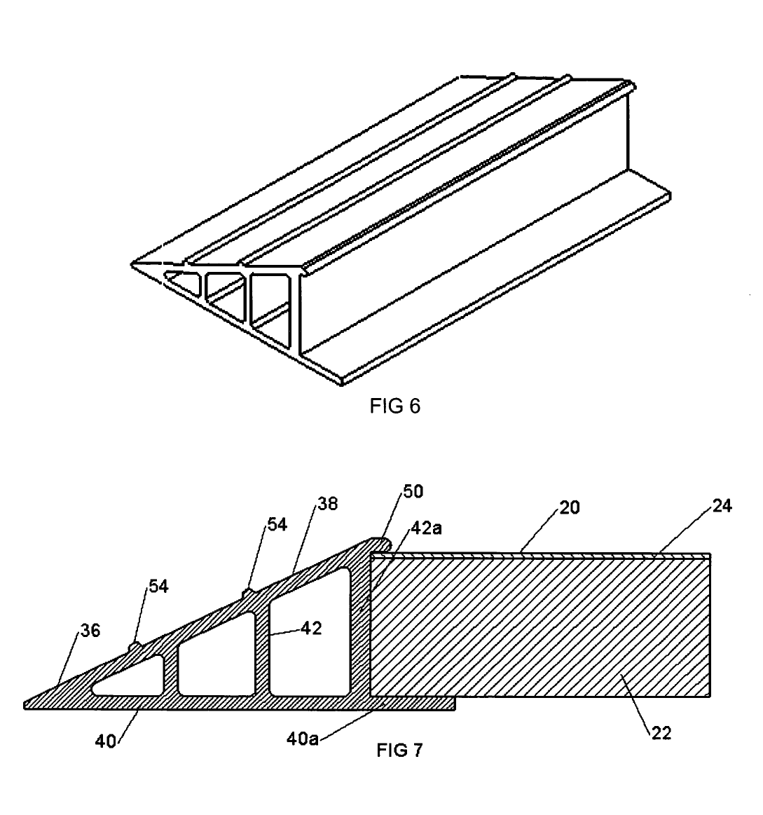

FIG. 3 displays partial cross-sectional view. The drawing is an enlarged view of a mat style construction with an angled approach to the surface of the mat (7). Closed cell foam (1) and the flexible membrane (2) are permanently bonded to each other. This bond can be accomplished by either using adhesive (3) or by other commercially available methods. The perimeter of the mat uses the edging shown in FIG. 6 with an angle between 15°-45°. This angle reduces the hazard of tripping on the mat edge and eases the egress onto the mat.

In FIG. 4 displays a rectangular mat (8). The mat's length, width and thickness dimensions are variable dependent upon the applications's needs and demands. Thickness can vary between ⅜″ to 1½″. The outer perimeter will be angled in conformance to FIG. 3.

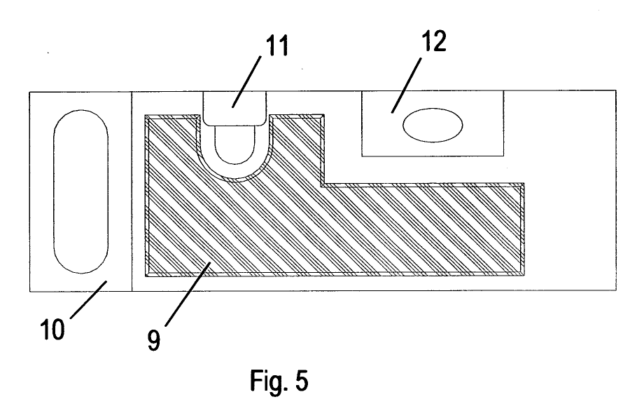

FIG. 5 displays a top view of a typical bathroom. This drawing shows a custom mat (9) design that wraps around the toilet (11) and in front of the tub (10). The mat (9) has a long rectangular area leading to the larger coverage area in front of the tub (10) and the toilet (11). This rectangular area may, dependent on length, extend in front of the sink and vanity (12). This rectangular area may be positioned in 90° increments. The mat construction (9) shall be in conformance to FIG. 3.

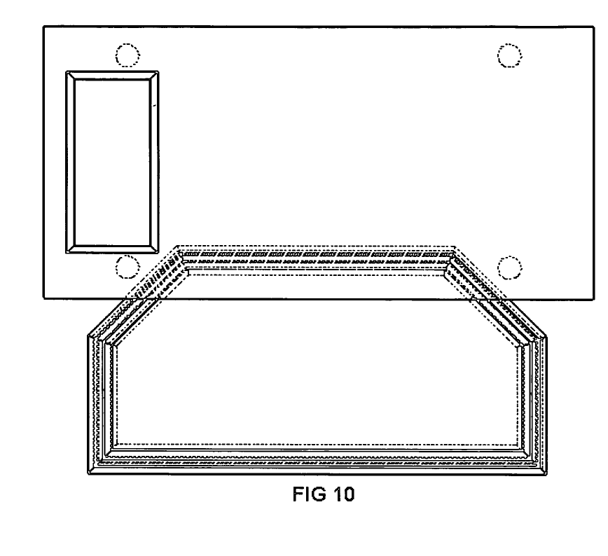

There is shown in FIGS. 6-10 inclusive, another embodiment of cushioned floor system in accordance with the present invention. The system comprises a laminated mat (20) consisting of a flexible cell foam core (22) and a flexible membrane (24) bonded to the core (20). In the present instance, the laminated mat (20) has a generally trapezoidal shape having generally parallel front and rear edges (26) and (28), the edge (26) being shorter than the edge (26) to define two angled edges (30). This system further includes a flexible ramp (60) surrounding the periphery of the mat (20) in the manner shown in FIGS. 8-10 inclusive. By this arrangement, the angled edges (30) fit between the leg supports of a bed and provide a cushioned mat essentially running the length of the bed.

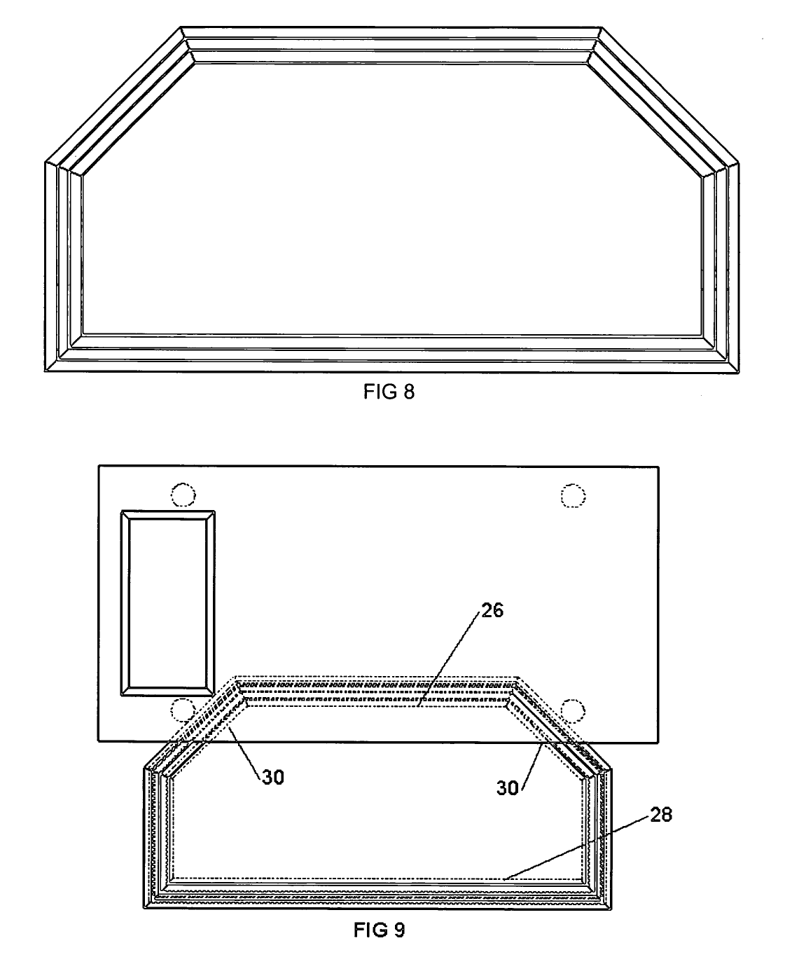

A flexible ramp (36) extends around the periphery of the mat (20) having an inclined face (38) to provide a trip free transition from the floor to the mat (20). The flexibility of the ramp (36) also minimizes injury to persons that would fall on the mat and ramp (36) such as patients. The ramp (36) is made of a plastic or rubber material and has a base (40) and a series of upstanding ribs (42) extending between the base (40) and the angled ramp face (38). The base (40) extends inwardly beyond the innermost rib (42a) to define an extended base portion (40a) which underlies the mat in the manner shown in FIG. 7. The mat nests in the extension (40a), inner most rib (42a) and short bead projection (50) of the slanted face (38). The ramp (36) is firmly secured in place by a suitable adhesive. The slanted face (38) of the ramp (36) has a pair of a longitudinally extending, spaced ribs (54) providing a traction means for wheel chairs and the like.

Even though a particular embodiment of the present invention has been illustrated and described herein, it is not intended to limit the invention and changes and modifications may be made therein within the scope of the following claims.

What is claimed is:

1. A cushioned floor covering system comprising a core made of a closed cell foam material having upper and lower faces, a flexible membrane bonded to the upper surface of said core and having a portion extending beyond at least one edge of the core to provide a baseboard when the floor covering is secured to a floor and said one edge lies adjacent a surface generally perpendicular to the floor and a micro-bacterial growth inhibitor.

2. A cushioned floor covering system comprising a core made of a closed cell foam material having upper and lower faces, a flexible membrane bonded to the upper surface of said core and a ramp secured to the periphery of the core and having a slated face merging with a support surface at its outer edge to prevent accidental tripping and being of a flexible construction to provide a cushion characteristic reducing the risk of injury to someone falling on the flooring system.

3. A system as claimed in claim 2 wherein the mat is of trapezoidal shape defining beveled, angularly disposed corner edges so that the mat can underlie beds having different front to rear wheel supports.
